(19) United States
(12) Patent Application Publication
(10) Pub. No.: US 2021/0334408 A1
(43) Pub. Date: Oct. 28, 2021

(54) Private Computation of Multi-Touch Attribution

(71) Applicant: Marin Software Incorporated, San Francisco, CA (US)

(72) Inventor: Wister Walcott, San Francisco, CA (US)

(73) Assignee: Marin Software Incorporated, San Francisco, CA (US)

(21) Appl. No.: 17/370,256

(22) Filed: Jul. 8, 2021

Related U.S. Application Data
(63) Continuation-in-part of application No. 16/158,344, filed on Oct. 12, 2018, now Pat. No. 11,087,027.

(51) Int. Cl. G06F 21/62; G06Q 30/02

(52) U.S. Cl. CPC G06F 21/6254; G06Q 30/0247; G06Q 30/0269

(57) ABSTRACT

A plurality of anonymized publisher-user identifiers are received at a processor, and a plurality of anonymized advertiser-user identifiers are received from an advertiser at the processor. Without de-anonymizing any publisher-user identifiers in the received plurality of publisher-user identifiers and any advertiser-user identifiers in the received plurality of advertiser-user identifiers, the processor obliviously computes an intersection among the received publisher-user identifiers and the received ad-user identifiers to create an intersection set containing a plurality of advertiser-user identifiers matched with publisher-user identifiers.

### CROSS REFERENCE TO RELATED APPLICATIONS

This application claims priority to, and is a continuation-in-part application of, U.S. patent application Ser. No. 16/158,344 titled “Privacy-Safe Attribution Data Hub,” and filed on Oct. 12, 2018, the contents of which are incorporated herein by reference in their entirety.

### BACKGROUND

The disclosed embodiments relate generally to processing and organizing data. In particular, the disclosed embodiments relate to systems and methods for acquiring and processing meaningful data in an anonymized and aggregated way that satisfies the data controller's privacy requirements, while providing a metric and recommendation for the effectiveness of an advertising event. Systems and methods according to various embodiments are capable of, for example, calculating a model for how advertising investments influence business models, while improving consumer privacy.

To estimate the effectiveness of advertising, advertisers typically desire to have visibility into all the ad interactions (typically, but not exclusively, clicks or views) that may have influenced a visitor on the path to a purchase. For the purposes of this application we will refer to these interactions as events. This visibility requires cooperation between advertising publishers (including advertising publishers' agents and others who work on behalf of publishers, such as advertising networks or advertising exchanges), who show the ads and receive the event information, and an advertiser (or a vendor operating on behalf of the advertiser), who collects all the events from across different publishers, attributing a contribution value to each event. A typical approach to attribution is to assign some score or credit to each event and then roll-up (or sum, or aggregate) those contribution values across all the events generated by each ad. From this information, the advertiser can then see, in total, the contributions of each ad compared to their investments in that ad and decide if they should continue investing in that ad and to what extent. For example, an advertiser may choose to turn off an ad if it is spending money, and generating events, but if the visitors from those events make no purchases (in other words, if the events are not involved in, or linked to, any purchases). Each event may have several identifiers that tie back to aspects of the ad served, for example the image or text of the ad, the website where the ad appeared, the physical location of the visitor, keywords the visitor typed that triggered the ad, or other ad creative or targeting characteristics. We will refer to these identifiers as ad IDs. Each event may also receive credit in the form of several different metrics (conversions, revenue, time on site, or other metrics of interest to an advertiser). The goal is to aggregate the credits across the user events for each ad ID and return those sums to use in optimizing the advertisements.

Various models exist to attribute a value of a purchase or conversion to a given ad event. Many advertisers use or want to use an established technique called multi-touch attribution, or MTA, to adjust their advertising investments and to better understand the customer journey, with the ultimate goal of maximizing purchases or conversions from the ad investment.

Thus, multi-touch attribution can be thought of as a process that gives variable credit or “weight” to different ads and marketing channels. More specifically, it can be considered as an equation where one side of the equation uses the customer's touch points as cost per event and its unique weight; on the other side of the equation is the conversion value.

Thus, delivering a robust multi-touch attribution (“MTA”) solution requires starting with data representing a complete set of clicks, views, or other event data, along with the associated user identifiers. Of course, for any subsequent conversion, capturing event data does not imply that these views will necessarily be counted, or be given credit at all, nor does it imply what amount of credit is given, if any. But as a precursor to attributing credit, the event data must first be collected. Once a set of event data is collected, all the ad events leading to a conversion can be considered by assigning a credit (also called a conversion credit or conversion value), often a fractional credit, to each event.

The current approach to this type of cross-event, cross-ad, and/or cross-publisher attribution sends detailed event information from publishers to an attribution processor. Because of the user-level data inside this data set, the data could be used for purposes beyond attribution, such as retargeting or user profiling. The information could include the advertisement itself, other devices for a given user, search terms a user typed, on what site they saw the ad, and the target demographic for the advertisement, potentially including information about age, gender, race, marital status, and other demographic information. Publishers want to be recognized for the contribution value of the ads they show, but due to increasing government regulation, disclosure requirements, a desire to protect their audience from being further monetized by other parties, or visitor preference, publishers are increasingly reluctant to expose this information to others.

These privacy issues can arise in the traditional MTA process because the attribution processor system can see which individual visitors interacted with which ads. Data about specific visitors, even if masked or “pseudonymized,” may potentially expose a visitor to unwanted retargeting or profiling, or expose a publisher's audience data for later use by third parties. In addition, several changes to the law over the last few years make collecting event data more difficult. Increasingly strict privacy, disclosure, technological, and “opt-in” regulations have made event-tracking data increasingly more difficult to assemble. Current providers, in response to early regulations, adopted a practice of “deterministic hashing” of email addresses. Deterministic hashing, also sometimes known as pseudonymization, assigns the same ID repeatedly to the same user. All parties typically use the same hash function and keys. An email deterministically hashed last year by publisher A will have the same value as an email deterministically hashed this year by publisher B. Pseudonymization has numerous issues: it is long-lived and repeatable, with the effect that over time, attribution providers and other vendors can build extensive dossiers on user behavior. Any party with the original email address can apply the same hashing rules and confirm if that user is in the set, a practice sometimes known as “linking”. As a result, hashing alone increasingly does not address privacy requirements in most contexts. Anonymization, in contrast, when applied by different parties, results in different output values for the same input values. Anonymization does not enable linking or profile-building. Anonymization is not repeatable across interactions, and is non-linkable.

To alleviate the challenges addressed above, the industry needs a different scheme, which provides anonymization instead of the current pseudonymous, hashing-based approach.

Thus, a need exists to share event data for cross-publisher, aggregated, anonymous, privacy-safe attribution, while preventing (rather than enabling) retargeting, audience building, data leakage, audience re-use, and profile building.

### SUMMARY

In an embodiment, a plurality of anonymized publisher-user identifiers are received at a processor, and a plurality of anonymized advertiser-user identifiers are received from an advertiser at the processor. Without de-anonymizing any publisher-user identifiers in the received plurality of publisher-user identifiers and any advertiser-user identifiers in the received plurality of advertiser-user identifiers, the processor obliviously computes an intersection among the received publisher-user identifiers and the received ad-user identifiers to create an intersection set containing a plurality of advertiser-user identifiers matched with publisher-user identifiers.

For each computed intersection in the intersection set, a conversion value is obliviously computed based on a conversion model, creating a conversion data set. The data set is aggregated, creating an aggregated data set that includes a total aggregated conversion credit value where each value is specific to an Ad ID but aggregated across all ad publishers and users. The processor then calculates an advertising recommendation, based on the aggregated conversion credit value, and sends the calculated advertising recommendation to an advertising entity.

In an embodiment, a processor receives a plurality of anonymized publisher-user identifiers, and also receives a plurality of anonymized advertiser-user identifiers. Without de-anonymizing any publisher-user identifiers in the received plurality of publisher-user identifiers, and any advertiser-user identifiers in the received plurality of advertiser-user identifiers, the processor obliviously computes an intersection among the received publisher-user identifiers and the received ad-user identifiers to create an intersection set containing at least one computed intersection among the plurality of advertiser-user identifiers and the publisher-user identifiers. A plurality of data in the conversion data set is then aggregated, and an advertising recommendation is calculated based on the aggregated data set.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system for processing, analyzing, and organizing data in a fully anonymous and aggregated way.

FIG. 2 is a flow chart of a process for calculating and sending an advertising recommendation to a publisher based on a remote analysis of encoded or encrypted data, according to an embodiment of the invention.

FIG. 3 is a flow chart of a process for calculating and sending an advertising recommendation to a publisher, based on a local analysis of encoded or encrypted data, according to an embodiment of the invention.

FIG. 4 is a table displaying an example of an encrypted ad data set, according to an embodiment.

FIG. 5 is a table displaying an example of a decrypted ad data set, according to an embodiment.

FIG. 6 is a table displaying an output tile representing an aggregated data set, according to an embodiment.

FIG. 7 is a flow chart of a method for calculating and sending an advertising recommendation to a publisher, based on analysis of anonymized or encrypted data, according to an embodiment of the invention.

FIG. 8 is a flow chart of a method for comparing anonymized user IDs, according to an embodiment of the invention.

FIG. 9 is a flow chart of a method for comparing anonymized user IDs, according to an embodiment of the invention.

### DETAILED DESCRIPTION

One or more of the systems and methods described herein describe a way of processing advertising data in an anonymized and aggregated way that satisfies the privacy requirements of the data controllers (later referred to as one or more advertising publishers and an advertiser) and the information requirements of the data processing party (also referred to as an attribution vendor or attribution processor system). As used in this specification, the singular forms “a,” “an,” and “the” include plural referents unless the context clearly dictates otherwise. Thus, for example, the term “a computer server” or “server” is intended to mean a single computer server or a combination of computer servers. Likewise, “a processor,” or any other computer-related component recited, is intended to mean one or more of that component, or a combination thereof. One skilled in the art will understand that a web page is a document on the Internet, and that a website comprises one or more web pages that are linked together. For the purposes of the present invention, the terms “ad” and “advertisement” are used interchangeably.

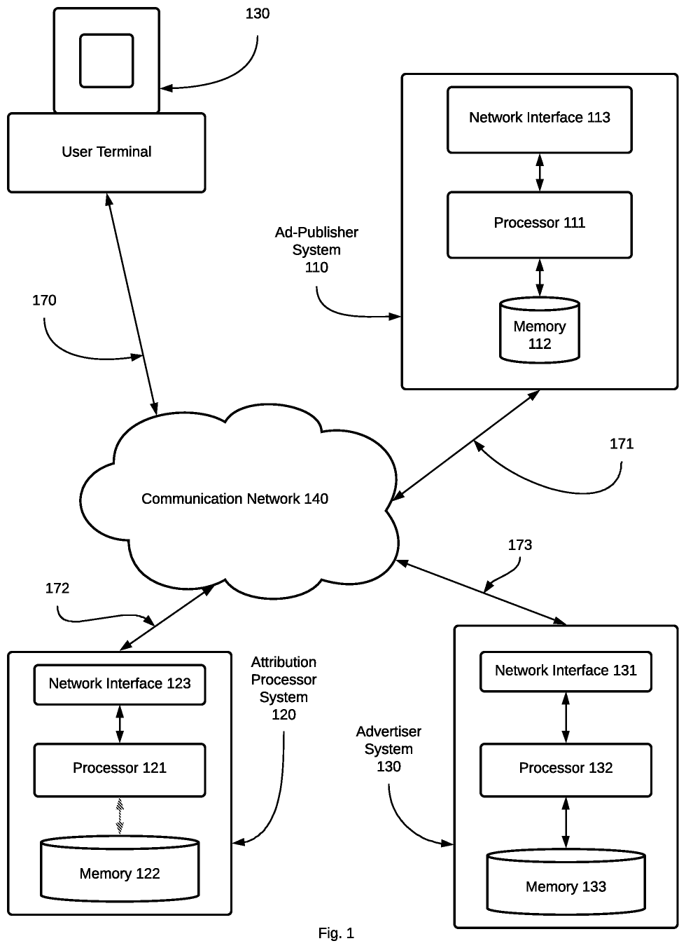

FIG. 1 is a block diagram illustrating a system for processing, analyzing, and organizing advertising data in an anonymized and aggregated way, according to an embodiment of the invention. The system comprises user terminal 130, ad publisher system 110, and attribution processor system (also called ad attribution vendor or attribution vendor) 120, and advertiser system 130. In an embodiment, attribution processor system 120, user terminal 130, ad publisher system 110, and advertiser system 130 are operatively coupled to one another through communication network 140 via network connection 170, which connects user terminal 130 to communication network 140, network connection 171, which connects ad publisher system 110 with communication network 140, and network connection 172, which connects attribution processor system 120 with communication network 140, and network connection 173, which connects advertiser system 130 with communication network 140.

Network connections 170, 171, 172, and 173 can be any appropriate network connection, physical, wireless, or otherwise, for operatively coupling user terminal 130, attribution processor system 110, ad publisher system 120, and advertiser system 130 to communication network 140.

Communication network 140 can be any communications network configurable to allow attribution processor system 120 to communicate with or to other network elements through communication network 140. Communication network 140 can be any network or combination of networks capable of transmitting information (e.g., data and/or signals) and can include, for example, a telephone network, an Ethernet network, a fiber-optic network, a wireless network, and/or a cellular network. In some embodiments, communication network 140 can include multiple networks operatively coupled to one to another by, for example, network bridges, routers, switches and/or gateways. For example, user terminal 130 can be operatively coupled to a cellular network, attribution processor system 120 can be operatively coupled to an Ethernet network, and ad publisher system 110 can be operatively coupled to a fiber-optic network. The cellular network, Ethernet network and fiber optic network can each be operatively coupled one to another via one or more network bridges, routers, switches and/or gateways such that the cellular network, the Ethernet network and the fiber-optic network are operatively coupled to form a communication network. Alternatively, for example, the cellular network, the Ethernet network, and the fiber-optic network can each be operatively coupled to the Internet such that the cellular network, the Ethernet network, the fiber-optic network and the Internet are operatively coupled to form a communication network.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection. In some embodiments, a user terminal, partner application and/or ad publisher system can be operatively coupled to a communication network by heterogeneous network connections. For example, a user terminal can be operatively coupled to the communication network by a WWAN network connection, a partner application can be operatively coupled to the communication network by a DSL network connection, and an ad publisher system can be operatively coupled to the communication network by a fiber optic network connection. In some embodiments, the data flowing across the network connections and communications network flow through a physical connection from one element to another.

In an embodiment, attribution processor system 120 comprises a network interface 123, a processor 121, and a memory 122. Attribution processor system 120 is operatively coupled to user terminal 130 and ad publisher system 110 through communication network 140 via network connection 172. User terminal 130 is connected to attribution processor system 120 through communication network 140 via network connection 170, and ad publisher system 110 is operatively coupled to user terminal 130.

In an embodiment, network interface 123 can be any network interface configurable to be operatively coupled to communication network 140 via network connection 172. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

In an embodiment, both the ad publisher system 110 and attribution processor system 120 can be based on any combination of hardware and software. In an embodiment, ad publisher system 110 includes network interface 113, processor 111, and memory 112. Ad publisher system 110 is operatively coupled to communication network 140 via network interface 113 and network connection 171. Network interface 113 can be any network interface configurable to be operatively coupled to communication network 140 via network connection 171. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

Processor 111 is operatively coupled to network interface 113 such that processor 111 can be configured to be in communication with communication network 140 via network interface 113. In an embodiment, processor 111 (and processor 121) can be any of a variety and combination of processors, and can be distributed among various types and pieces of hardware, or even across a network. For example, a processor can be any combination of aggregation processor, attribution processor, and optimization processor, including some or all of each component. Such processors can be implemented, for example, as hardware modules such as embedded microprocessors, microprocessors as part of a computer system, Application Specific Integrated Circuits (“ASICs”), and Programmable Logic Devices (“PLDs). Some such processors can have multiple instruction executing units or cores. Such processors can also be implemented as one or more software modules in programming languages as Java, C++, C, assembly, a hardware description language, or any other suitable programming language. A processor according to some embodiments includes media and program code (which also can be referred to as code) specially designed and constructed for the specific purpose or purposes. A processor according to some embodiments includes a trusted execution environment, also known as a TEE or enclave. A TEE protects data inside the TEE from being viewed by any code, or system, or person, outside the TEE. A TEE also measures what code has run on the data inside the TEE and attests to that measurement. This measurement and attestation serves to verify that the only code to run on the data is the code that the parties expect. Examples of current TEEs may include, but may not be limited to, Intel Software Guard Extensions (Intel SGX), AMD PSP, AMD SEE, ARM TrustZone, RISC MultiZone STEE, and Google Asylo.

Processor 111 is also operatively coupled to memory 112 which, in an embodiment, can be used to store advertisements, advertisement-related data, web pages, searches, search results, and any other data necessary for attribution processor system 120 to perform at least a part of the invention. In an embodiment, memory 112 (and memory 122) can be a read-only memory (“ROM”); a random-access memory (RAM) such as, for example, a magnetic disk drive, and/or solid-state RAM such as static RAM (“SRAM) or dynamic RAM (“DRAM), and/or FLASH memory or a solid-data disk (“SSD), or a magnetic, or any known type of memory. In some embodiments, a memory can be a combination of memories. For example, a memory can include a DRAM cache coupled to a magnetic disk drive and an SSD.

In addition to memories 112 and 122, some embodiments include another processor-readable medium (not shown in FIG. 1) having instructions or program code thereon for performing various processor-implemented operations. Examples of processor-readable media include, but are not limited to: magnetic storage media Such as hard disks, floppy disks, and magnetic tape; optical storage media Such as Compact Disc/Digital Video Discs (“CD/DVDs), Compact Disc-Read Only Memories (“CD-ROMs), and holographic devices: magneto-optical storage media such as floptical disks; Solid state memory such as SSDs and FLASH memory; and ROM and RAM devices. Examples of program code include, but are not limited to, micro-code or micro-instructions, machine instructions (such as produced by a compiler), and files containing higher-level instructions that are executed by a computer using an interpreter. For example, an embodiment (or parts thereof) may be implemented using HTML, Java, C++, or other object-oriented programming language and development tools. Additional examples of program code include, but are not limited to, control signals, encrypted code, and compressed code.

In some embodiments, ad publisher system 110 can be virtual devices implemented in Software such as, for example, a virtual machine executing on or in a processor. For example, an ad publisher system or an attribution processor system can be implemented, at least in part, as a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in software executing in, or as part of, a virtual machine.

Likewise, Processor 121 is operatively coupled to network interface 123 such that processor 121 can be configured to be in communication with communication network 140 via network interface 123. Processor 121 is also operatively coupled to memory 122 which, in an embodiment, can be used to store an attribution model, attribution-model data, advertisement-related data, program code, analytics, web pages, and any other data necessary for attribution processor system 120 to perform at least a part of the invention.

In some embodiments, an attribution processor system can be a virtual device implemented in software such as, for example, a virtual machine executing on or in a processor. For example, an attribution processor system can be a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in software executing in, or as part of, a virtual machine.

User terminal 130 can be any kind of user platform, such as a desktop computer, a laptop computer, a mobile telephone, a mobile tablet, or any device that allows a user to view advertisement.

In an embodiment, a user can use user terminal 130 to log into their user accent on, for example, a social-media website. When the user logs into their account, they are served an advertisement by ad publisher system 110 via communication network 140 where it can be viewed or clicked on by the user. For the purposes of the present invention, such an event is called an advertising event, and some set or subset of the ad event details (that is, the data about the ad-viewing event) are received, via communication network 140, by ad publisher system 110, which can store the ad-event details in memory 112. Ad-event details can include, for example, the account information of the user, their name, age, gender, and other demographic information. The ad-event details can also include the advertisement itself, an identifier (encrypted, encoded, or not) that refers to the advertisement, what type of advertisement is served, the platform it is served on, the date it is served, the time it is served, the type of ad campaign, the product or other subject matter contained in the ad, whether the campaign is branded or nonbranded, and any other advertising information relevant to an ad publisher or an advertiser. For the purposes of the present invention, the term “identifier” can also be referred to as an “ID.”

In an embodiment, for a given set of advertisements, ad publisher system 110 receives ad-event details that pertain to a single user. In an embodiment, for a given set of advertisements, ad publisher system 110 receives event details that pertain to a plurality of users. In an embodiment, advertiser 130 receives a purchase from one or more users, and ad publisher system 110, and receives data indicating that the one or more users has purchased the product that is the subject of the ad.

In an embodiment, processor 111 accesses the event details (the data set) in memory 112 and sends them, through network interface 113, and via communication network 140, to attribution processor system 120. Once received, processor 121 can process the received data set according to an attribution model, applying an attribution credit to each ad event found in the converting events data, creating an attribution data set.

In an embodiment, processor 121 can include a trusted execution environment (or TEE), which is a secure area of a processor that guarantees code and data loaded inside to be protected with respect to confidentiality and integrity. A trusted execution environment is typically an isolated execution environment that provides security features such as isolated execution, integrity of applications executing with e trusted execution environment, along with verifiability of such execution.

In an embodiment, working within a TEE may require additional technical considerations, These considerations may include the following:
The TEE may implement its own authentication and encryption separate from the attribution processor. This may be enabled with the use of asymmetric encryption such as used within transport layer security (TLS) or secure sockets layer (SSL), to encrypt the data itself, or to exchange symmetric keys for further data exchange.
The TEE may have and serve a certificate from a third party to vouch for its identity.
Because of limited working memory within the TEE, the TEE may have to split apart the processing work in various ways, for example saving partial work out to the main (non-TEE) memory of the broader computer. If this happens, the partial work is re-encrypted to prevent viewing by non-authorized code or users.

Once the credit for each conversion event is applied, in an embodiment, the attribution data set can be aggregated directly across a plurality of users, or is sent from processor 121, through communication network 140, to ad-publisher system 110. Ad-publisher system then aggregates the data across a plurality of users, and then sorts and processes the aggregated data by ad event to provide an aggregated attribution credit for each ad event. In an embodiment, the aggregated data is packaged into an aggregated data set and then sent back, via communications network 140, to attribution processor system 120, for further processing. In an embodiment, processor 121 receives the aggregated data set and, based on the aggregated data set, calculates an advertising recommendation that can then be sent back, via communication network 140, to an ad publisher.

In an embodiment, once the attribution credit for each ad event is applied by processor 121, it is further processed by processor 121 which aggregates the data across the plurality of users, and then sorts and processes the aggregated data by ad event to provide an aggregated attribution credit for each ad event. Processor 121, in an embodiment, then further processes the data to create an advertising recommendation that is then sent to an ad publisher.

Similar to ad publisher system 110 and attribution processor system 120, embodiments of the invention include advertiser system 130, which includes network interface 131, processor 132, and memory 133.

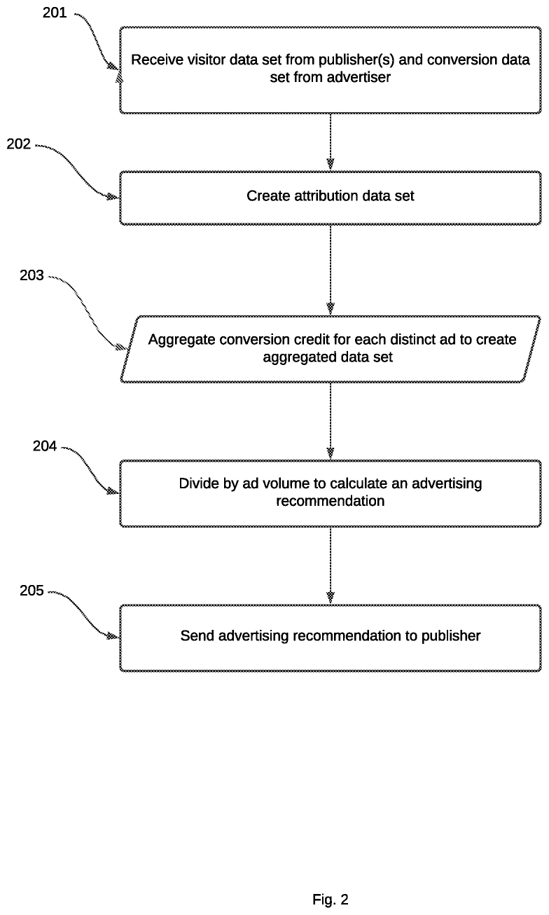

FIG. 2 is a flow chart of a process for calculating and sending an advertising recommendation to a publisher, according to an embodiment of the invention. In an embodiment, the process in FIG. 2 is implemented by at least a subset of components in FIG. 1. At 201, a first processor receives an ad data set that includes information about advertising events. In an embodiment, the information is about advertising events that have been viewed by at least one user who has been served an ad or a plurality of ads. In an embodiment, the information is about advertising events that pertain to a product that has been purchased by the user. In an embodiment, the advertising events can include different advertisements that have been served on one or more platforms. In an embodiment, the advertising events can include views of the same advertisements, but at different times, across one or more platforms. In yet another embodiment, the advertising events can include a view of or a click on any combination of advertisements served at any combination of times, on any combination of platforms.

For the purposes of the present invention, the term platform means a type of device capable of receiving a broadcast or connecting to a network, and then displaying a served ad. Examples of different platforms include, but are not limited to, personal computers, laptops, mobile or cellular telephones, electronic tablets, electronic books, tablets, and any other appropriate device.

In an embodiment, the event data set includes an ad identifier that identifies the particular ad that was served or published. For example, the ad may be text, still image, or video, or a combination of those elements. In an embodiment, the event data set further includes information about when the ad was served, and what keyword or placement or user action or attribute triggered the ad to be shown to that user.

In an embodiment, the ad data set, or a subset of the ad data set, is encoded or encrypted before it is received at the first processor. In an embodiment, some elements may be encoded or encrypted such that they can be used or understood only by the publisher. For example, instead of using an ad ID known to the processor, the publisher would substitute a replacement ad ID that the publisher can look up later. This prevents the processor from looking up the targeting details of that ad to infer attributes about the user such as their race or gender. In an embodiment, the encoding is “salted” with a timestamp, order ID, or some other factor so that the processor cannot infer that two ads appearing for different users or at different times are the same ad. In an embodiment, some de-precisioned (or, higher-level, less fine-grained) information about the ads are retained, such as the overall objective or theme for the ad. In an embodiment, order ID is retained. This ID can be used by the processor to combine these ad events with events from other publishers. All other data elements can be removed, such as User ID, browser signature, and IP address. The term encoded in this context means that the ad information in the data set includes information that is processed in a way that allows the first processor to uniquely identify the ad to the ad publisher later, but uses private IDs that are known only to the ad publisher. For example, the IDs could be combined with the hour of the ad event and then encrypted using a symmetrical encryption algorithm such as 3DES or AES. In an embodiment, the IDs could be replaced with a sequence number, whereby the publisher would record the mapping of the original ad IDs with the sequence number so as to decode them later. In an embodiment, such data includes data representing at least one of time, date, and IP address of target, but before being sent to the first processor, the data has been subjected to a deprecision model, thus reducing the precision with which the data has been collected, denying the processor the ability to identify the person to whom the ad was served. For example, if an advertisement includes a timestamp, 11:21 am may be converted to 11:20 am, 11:15 am, 11:30 am, 11:00 am, or noon under different precision targets. This prevents the processor from associating conversion events with specific web visits by using the time ID. In an embodiment, the precision target is selected by the publisher based on the data volumes and the anonymity required.

In another embodiment, timestamps are both de-precisioned to the hour or day, and also encrypted (at higher precision, for example, to the minute) by the ad publishers and advertiser. The encryption format will follow the Goldwasser-Micali vector format. If two or more events occur with the same de-precisioned timestamp, a process will enable the timestamps to be compared against each other to determine sequence without exposing the timestamps themselves.

At 202, the first processor creates an attribution data set. In an embodiment, an attribution data set is created by merging the ad data sets received from each of one or more publishers with the conversion data set received from the advertiser, and applying to each ad event in the received data (or at least to a subset of ad events) an attribution credit based on one or more predetermined attribution models. One skilled in the art will appreciate that any practicable attribution model, or a combination of these models applied in parallel, can be used to create the attribution data set.

In an embodiment, the ad identifiers in the ad data set are encoded or encrypted such that the first processor cannot determine which ad is referred to by the ad identifier.

At 203, the data is aggregated across a user or users, creating an aggregated data set that organizes the data by ad identifier. In an embodiment, the aggregated data set includes, for each ad element or ad identifier (hereafter referred to as an ad ID), the total of all the attribution credits that have been aggregated over a plurality of converting users for that ad ID.

Provided a sufficient quantity of users exists, the act of aggregation further anonymizes the data. If an insufficient quantity of users exists for a particular ad ID, the credits for that ad ID will be placed into a “catch-all” category.

In an embodiment, at 204, the aggregated data set is divided by the historical spending on that ad to calculate a return on investment for that ad or another advertising recommendation, which can include at least one of the following recommendations: which ad events to use or to not use to increase the likelihood of a conversion, which platform on which to serve the ad to increase the likelihood of a conversion, what season, day, and/or time to serve the ad to increase the likelihood of a conversion, what demographic to serve the ad to, whether the ad should be branded or unbranded, where to place ads on a web page, how often to serve the ad, and any other factor that can be used to improve the financial performance of that ad.

Once the advertising recommendation is calculated, at 205, it can be sent back to the advertising publisher for implementation. For example, the recommendation can be sent to an ad publisher telling the ad publisher which advertisements to turn off, discard, or abandon, or which advertising campaign should be given prominence at a certain time.

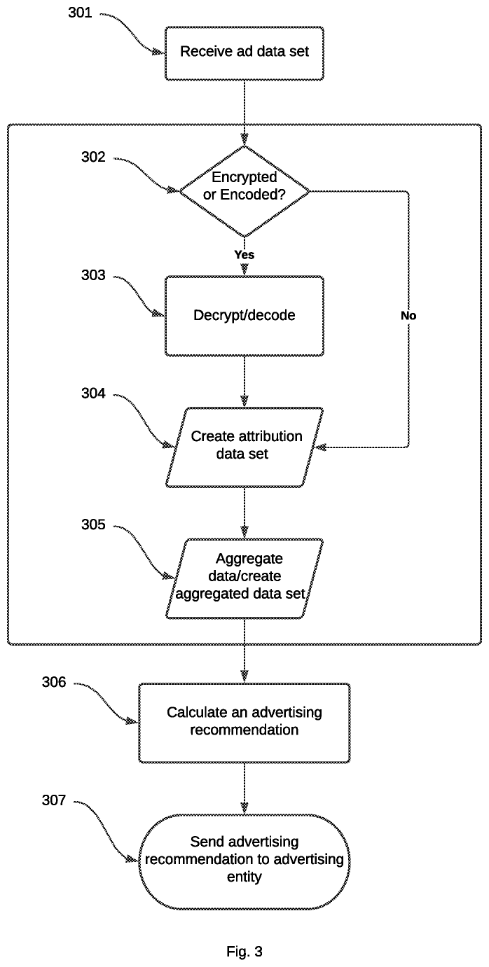

FIG. 3 is a flow chart of a process for calculating and sending an advertising recommendation to a publisher, according to an embodiment of the invention. In an embodiment, the process in FIG. 3 is implemented by at least a subset of components in FIG. 1.

At 301, an ad data set is received. In an embodiment, the ad data set is received at a first processor from an advertising entity such as an ad publisher. The ad data set includes an ad identifier that identifies the particular ad that was served or published to one or more users. In an embodiment, the ad data set includes information about an advertisement of a product that was purchased by a user. In addition to the ad identifier, the ad data set further includes ad information, that is, information about the ad to identify when the ad was served, including day, date, and time, who the ad was served to, the demographic of the receiver of the ad, the type of ad campaign the ad belongs to, and whether the ad is branded or nonbranded.

In an embodiment, the ad data set, or a subset of the ad data set, is encoded or encrypted before it is received at the first processor. In an embodiment, the ad data set is encoded or encrypted by the processor. The ad data set may include one or more ad identifiers for each ad event, for example audience, device, ad text, targeting such as search term, geography, or search history. There may also be one or more labels about the ad event, identifying for example a demographic target or the high-level objective. The data set may also include data representing the time and date of the event. In an embodiment the ad data set is encoded or encrypted. In another embodiment, a subset of the ad data set is encoded or encrypted.

At 302, in an embodiment, the first processor determines if the data in the ad data set, or any subset of data in the ad data set, is encoded or encrypted. If yes, the processor decodes or decrypts the data, at 303, and then further processes the data at 304 to create an attribution data set in which, using an attribution model, at least one ad event in the data set is assigned an attribution credit that represents a value of the ad event according to an attribution model.

In an embodiment, the ad publisher encrypts all data elements in the data set such that only a processor TEE can read the data. Using the TEE and other processing resources, the processor merges the data set with similar data sets from other publishers to build a consolidated data set of ad events for converting users. The processor then applies the attribution model and aggregates the credit. The aggregated total credit is communicated from the TEE to the processor using decrypted or cleartext Ad IDs and totals. Thus, at 303, the data is decrypted in a trusted execution environment.

In an embodiment, decryption 303 can occur later in the process, provided that the first processor has enough information to create the attribution data set. Once the attribution data set is calculated, any data showing a user interaction, or showing any other data that can be used to identify the user, can be discarded. In an embodiment, the original data set, or any subset thereof, can be discarded at any time after it is decrypted.

In an embodiment, the ad data set includes at least one encoded or encrypted ad identifier, and wherein at least a subset of the remaining data in the ad data set is unencoded or unencrypted. In an embodiment, the ad data set includes at least one encoded or encrypted ad identifier, and further includes encoded or encrypted data that is related to each encoded or encrypted ad event.

At 305, the attribution data set is processed to create an aggregated data set, wherein the data for each ad event is combined such that each ad element (as uniquely distinguished by a unique ad ID) has a value that is the aggregated value of all the ad events for that ad element. Examples of ad elements could include, but are not limited to, a specific geography (for example, Chicago); a specific keyword target (for example, “red shoes”); or a specific ad text (“Sale on shoes”).

Once the aggregated data set is calculated, it is used to calculate an advertising recommendation, at 306, which is then sent to an advertising publisher at 307.

In an embodiment, aggregates are computed within a confidential environment such as a trusted execution environment that the attribution processor cannot penetrate, on a data set of ad events provided by the advertising entity. In an embodiment, the aggregation step will further aggregate any ad IDs that, after aggregation, did not receive credit from at least a specified number of different ad events, for example 2 or 3 ad events. For the purposes of the present invention, “further aggregate” means that if there were for example, ad IDs a, b, and c, each of which had only one total conversion to their credit, then the system would aggregate them together as “other” with a total of 3. In an embodiment steps 302 through 306, or any subset thereof, are performed in a TEE or other trusted execution environment.

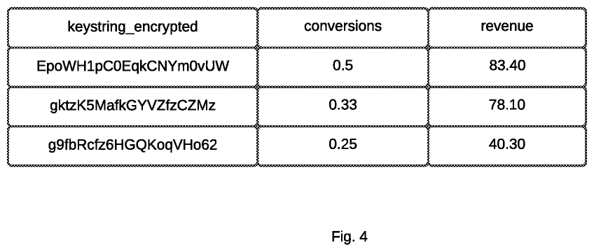

FIG. 4 is a table displaying an example of an encrypted ad data set, according to an embodiment. In an embodiment, the input file includes a plurality of rows of encrypted data, each row representing both the ad ID associated with an advertising event, along with a user ID for a user associated with that advertising event. The input file, in an embodiment, includes at least three columns, with column 1 being the encrypted keystring, column 2 representing the conversion value of that row's advertising event, and column 3 representing the revenue associated with each conversion. For the purposes of the present invention, a keystring is a collection of one or more ad IDs along with their associated values.

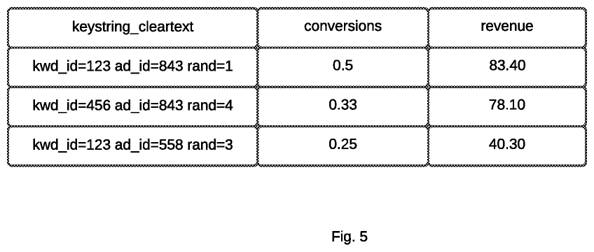

FIG. 5 is a table displaying an example of a decrypted ad data set, according to an embodiment. In an embodiment, as can be seen in the table in FIG. 5, each row includes a cleartext version of a user ID and an ad ID.

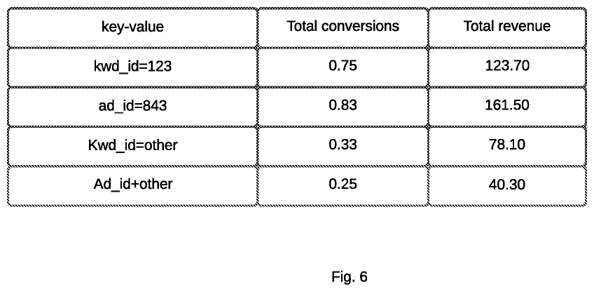

FIG. 6 is a table displaying an output file representing an aggregated data set, according to an embodiment. The aggregated data set in this embodiment comprises one row per key-value combination found in the ad data set, with the summed metric for each key value. In this embodiment, each row contains: key and value, along with metrics totals (total conversions and total revenue), with one metric displayed per field.

In an embodiment, if a TEE is used, the first processor can provide to the publisher a public key to be used for encrypting the data to be received by the first processor. The advertising entity can validate the authenticity of the public key as desired. In an embodiment, the first processor receives from the publisher a public key to be used for decrypting the data to be received by the first processor. The first processor validates the authenticity of the public key as desired.

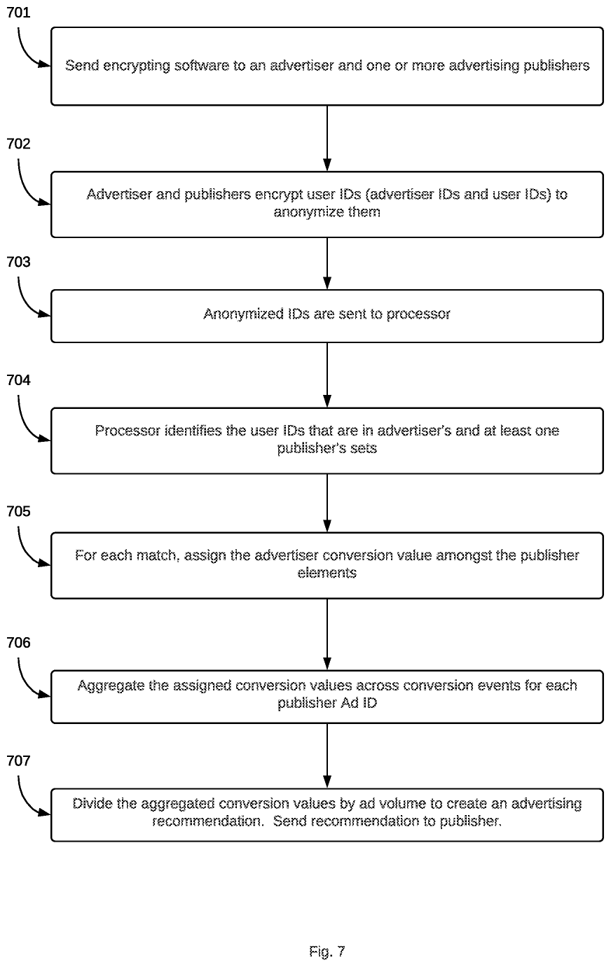

FIG. 7 is a flow chart of a method for calculating and sending an advertising recommendation to a publisher, based on a local analysis of encoded or encrypted data, according to an embodiment of the invention. The method assumes that an advertiser has a number of clients, each with a distinct user ID, and that the advertiser uses an advertising publisher, where the advertising publisher also has a number of clients, each with a distinct user ID. The advertiser and publishers use a common set of user IDs, for example, an email address.

At 701, user-ID anonymizing software is received at the advertiser and at the ad publisher. In an embodiment, anonymization software are sent to a computer processor at an advertiser, and to a computer processor at an advertising publisher. The anonymization software may be sent by a third-party data-processing party, or may be provided by the advertiser or the advertising publisher, and must provide any receiving party the ability to create anonymized versions of their user IDs. In an embodiment, the advertiser and one or more publishers generate a shared key which they keep hidden from the processing party, and use that key to encrypt their respective input values, creating a unique output value for each user ID, in a way that allows a processing party to calculate if the advertiser and advertising publisher had input values in common, without the processing party being able to derive or confirm those original input values. In a different embodiment, the shared key is used only to generate a private and public key pair at each of the advertiser and one or more publishers, and that shared key is not used to encrypt the input data itself

At 702, the advertiser and the advertising publisher (also called an ad publisher or publisher) use the received software to anonymize the respective user IDs. In an embodiment, the received software is used to anonymize, or encrypt, the user IDs. This creates a set of encrypted data for the advertiser E(A,f_{A}) and a set of encrypted data for each publisher E(P,f_{P}), wherein each encrypted user ID for the advertiser A has a value, and each encrypted user ID for the advertising publisher also has a value. In the above notation, E(X,y) represents an encryption of the set X using the key y. fₓ represents the private encryption key for party x.

In an embodiment, at 703, for multiple parties, all parties (A and P₁-Pₖ) send their encrypted sets to the data processing party.

Once received at the data-processing party, at 704, in an embodiment, the data-processing party further advances the encryption of the data provided by applying public key g_{P} for each publisher's provided data set. This public key is applied to E(p,f). Thus, the new data values are E(E(P,f),g). The encryption function E is selected to provide consistency under multiple successive applications such that E(E(P,f),g)=E(P,t) where f and g are selected specifically relative to t. This quality provides that the single encryption E(P,f) provides full anonymization against the data processing party, that the publisher and advertiser parties' transmitted data cannot be compared without further encryption resulting in multiple encryption, and that the multiple encryption E(E(P,f),g) from different parties can be compared against each other.

At that point, the encrypted values from all contributing parties are encrypted to equivalent levels. The data-processing party then obliviously computes the intersection of the advertiser and ad publisher data. For the purposes of the present invention, an oblivious computation is a computation that has no view into the source information. Thus, the data-processing party computes the intersection without decrypting or otherwise de-anonymizing the data, and thus without seeing any user IDs and without the ability to match users to personally identifiable information. Even starting with some emails that are known to be present in the set, the data-processing party is unable to confirm if those users are present in a contributed set, as it does not know the encryption keys used to perform the encryption. Furthermore, each party uses a different encryption level for their initial encryption, preventing any one party from reverse-engineering another party's data set, even if it were to obtain access to that data set.

In general, the intersection means a match between a value representing a user ID for an advertiser and a value representing a user ID for an ad publisher. In calculating overlaps, the data-processing party runs through each publisher's encrypted IDs, looking for a match with the advertiser's list of encrypted IDs.

At 705, for each intersection found between the advertising data and the ad publisher data, a conversion credit is assigned amongst the matching ad events. In an embodiment, weightings are applied according to a series of rules set by the advertiser and communicated to the data processing party ahead of time. Rules can include how much weight to give to various events, including (but not limited to) any or all of the following: last click (publisher with the earliest time stamp); first click (publisher with earliest time stamp); even weighting (all matching publisher events get the same weighting); “U shaped” (first and last get outsized credit and ones in the middle get less); and/or recency weighted (ascending or descending weighting over time). In an embodiment, conversion events can be weighted giving greater weight to certain types of events over other types of events. One skilled in the art will understand that the aggregate sum of the credit allocated should total the conversion event value, but it may be distributed differently depending on the matching publishers.

Some of the calculations require knowing the relative sequence of the matching events, such as first or last. In an embodiment, the publishers may send a de-precisioned timestamp together with a higher-precision timestamp in the form of an encrypted vector. If an overlap occurs and the two de-precisioned timestamps are equal at their lower precision, then a privacy-preserving, tie-break process is followed to determine the earliest or latest event. In this tie-break process, the data processing party sends each publisher in the tie all the encrypted time vectors for the other publishers in the tie. Each publisher then selects the element corresponding with their high-precision timestamp, further encrypts it, and returns it to the data processing party. The data processing party exposes all these selected elements back to the group of publishers, who can tell by evaluating that element who was earlier or later between that pair of publishers. The publisher that is smaller than all the others is the earliest.

At 706, for each contributing ad event, the values of the conversion credits are aggregated for each distinct advertising ID. Aggregated here refers to the addition of all the conversion credits, and (separately), the addition of all the credited revenue, for each ad ID. As an example, Ad ID 1 may have been seen by 100 users on a given day, of which 12 of those users purchased a product. Ad ID 1 would receive 12 conversion credits.

In an embodiment, at 706, for Ad IDs with aggregated conversion events below a certain threshold, the data processing party may further aggregate Ad IDs together to mask specific user identities. For example, if an ad received a single impression, the visitor who saw that ad can be identified by one party (the publisher). If that ad receives a conversion credit, and the publisher learns about that conversion credit, then the publisher can infer which visitor converted at the advertiser's site. Instead, the data processing party may simply say that all the ads under a certain campaign received multiple conversion credits, thus masking the identity of the visitors involved.

If the aggregated conversion credits decrease or increase upon a publisher removing or adding one specific user, then a malicious publisher could know that that user converted at the advertiser site. In an embodiment, at 706, the data processing party may block or approximate successive comparisons using input data that overlaps significantly with a recent comparison.

In an embodiment, at 707, the aggregated value is sent to an advertiser so that the advertiser can determine which ad events are most valuable. In an embodiment, at 707, instead of sending the aggregated value to the advertiser, the data-processing party can use the aggregated value to calculate an advertising recommendation. The calculated recommendation is sent to the publisher, who acts on the recommendation.

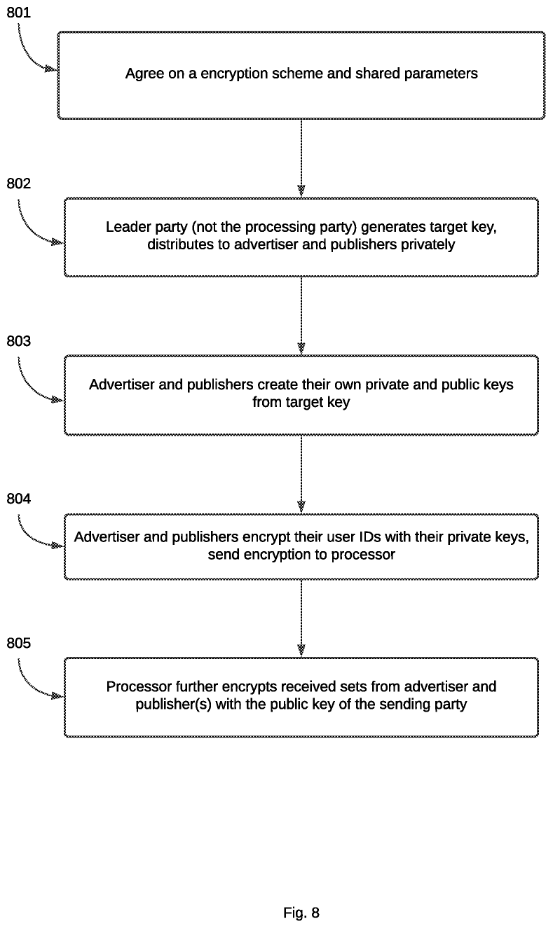

FIG. 8 is a flow chart of a method for applying an appropriate encryption. At 801, the parties agree on an encryption approach. In an embodiment, encryption can be done using modular exponentiation cryptography. In another embodiment, encryption can be done using elliptic-curve cryptography.

Under modular exponentiation, one party of the advertiser or publishers, but not including the data processing party, at 802, selects an exponentiation level t at random. The value t will serve as a semi-private or shared key. There does not need to be a complementary decryption key as the values will never be decrypted. This party is referred to as the leader party. The leader shares the key privately to all the other parties, excluding the processor.

At 803, under modular exponentiation, each party creates a set of 3 component keys: private keys f and h, and public key g, at random or its own discretion such that t=fg+h.

At 804, under modular exponentiation, each publisher and the advertiser encrypt their user IDs twice, once with their key fₚ and separately with their companion private key hₚ, resulting in sets which we call E(p,f) and E(p,h) respectively. Each party sends the two encryptions to the data processing party along with that publisher's public key gₚ and an optional index value allowing them to identify that user later for tie-break purposes. Keys f and h are not shared and can be discarded. In an embodiment, the data can be shuffled into a random order.

At 805, under modular exponentiation, the data processing party receives the encrypted sets and each publisher's public key gₚ. The processor applies further exponentiation to E(P,f) and multiplies that result by E(P,h). It will be clear to one skilled in the art that

(m^{f})^{g}m^{h}=m^{fg+h}

In an embodiment, the parties use Elliptic Curve Cryptography or ECC, instead of modular exponentiation, to encrypt the User IDs. At 802, under ECC, the leader shares a private key t common to the publishers and advertiser.

At 803, under ECC, each publisher and the advertiser independently create at random or at their discretion their own private key f and a public key g such that t=f+g, where t is the same across all parties, but each party can have a different f and a different g.

At 804, under ECC, each party iterates its ECC point multiplications f times and sends the result E(f) to the data processing party along with their public key gₚ.

At 805, under ECC, the processor iterates each received data set with gₚ point multiplications to bring it to a common encryption level across all parties.

Each publisher may also include information on the ad seen, the type of user interaction, and the timestamp of the interaction. The advertiser may include information on the type of purchase, the product purchased, and the timestamp of the purchase. These data elements may be potentially de-precisioned and/or encrypted to protect user privacy.

In an embodiment, additional ad-conversion information is sent to the data processing party along with the encrypted user IDs for use in applying conversion credits to the ad events. Such ad-conversion information can include the time of the conversion, the value of a conversion, the product purchased, whether the customer is new or a repeat customer, payment method, and other related data.

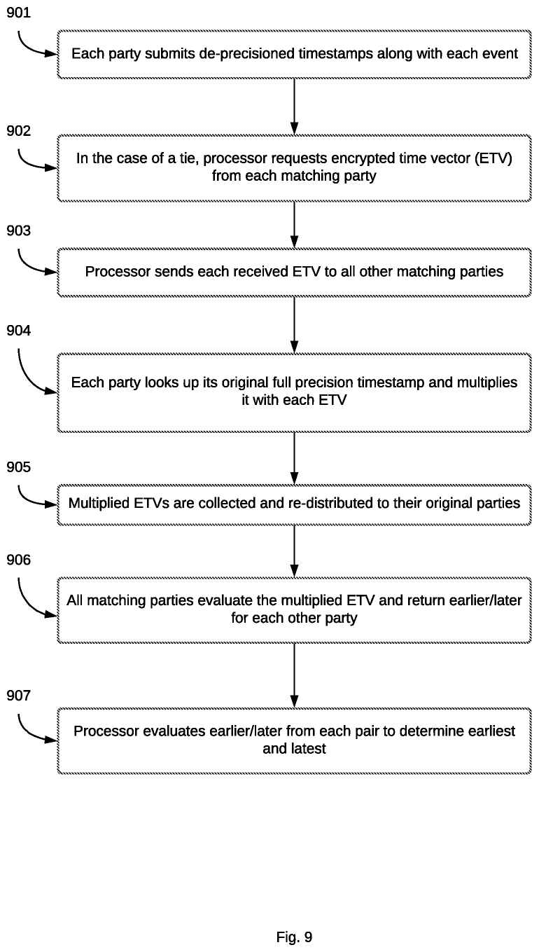

FIG. 9 is a flow chart of a method for comparing anonymized user IDs, according to an embodiment of the invention. At 901, the parties submit de-precisioned timestamps to preserve user privacy. De-precisioned can, for example, include removing just the seconds and minutes from the time stamp, leaving the time to the hour. De-precisioned can also mean removing the seconds, minutes, and hour, leaving just the date of the interaction. In the case of de-precisioned timestamps, it may be important to resolve any tie values between the timestamps to establish sequence for the purpose of assigning conversion credit. Diagram 9 illustrates a privacy-safe tie-break procedure.

At 902, the advertiser and publisher(s) calculate an encrypted time vector or ETV and submit it to the processor for the tie-break (or in advance for all data elements). In an embodiment, the encrypted time vector or ETV is calculated using the Goldwasser-Micali construction. This time vector is indecipherable by other parties.

At 903, the processor distributes each party's ETV to all the other parties in the tie-break. At 904, the receiving tie-break parties multiply each received ETV with their original full-precision timestamp in a manner to continue to mask that timestamp.

At 905, the processor collected the multiplied ETVs and re-distributes them to their original owners, who can then discern if their timestamp is earlier or later than each of comparison parties at 906. The parties return this finding to the processor who then, at 907, determines the complete order of parties in the tie-break.

One skilled in the art will understand, in the context of embodiments of the invention, that the term “a combination of” includes zero, one, or more, of each item in the list of items to be combined.

Additionally, one skilled in the art will understand, in the context of embodiments of the invention, that the term “advertising publisher” also includes advertising publishers' agents and others who work on behalf of publishers, such as advertising networks or advertising exchanges, and that the term “advertiser” also includes a vendor or agent operating on behalf of the advertiser.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

Although specific advantages have been enumerated above, various embodiments may include some, none, or all of the enumerated advantages. Other technical advantages may become readily apparent to one of ordinary skill in the art alter review of the following figures and description.

It should be understood at the outset that, although exemplary embodiments are illustrated in the figures and described above, the present disclosure should in no way be limited to the exemplary implementations and techniques illustrated in the drawings and described. herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(t) unless the words “means for” or “step for” are explicitly used in the particular claim.

I claim:

1. A method, comprising:
receiving, at a processor, from a plurality of ad publishers, a plurality of anonymized publisher-user identifiers;
receiving, at the processor, from an advertiser, a plurality of anonymized advertiser-user identifiers;
at the processor, without de-anonymizing any publisher-user identifiers in the received plurality of publisher-user identifiers and any advertiser-user identifiers in the received plurality of advertiser-user identifiers, obliviously computing an intersection among the received publisher-user identifiers and the received ad-user identifiers to create an intersection set containing a plurality of advertiser-user identifiers matched with publisher-user identifiers;
for each computed intersection in the intersection set, obliviously computing a conversion value based on a conversion model, creating a conversion data set;
aggregating the data in the conversion data set, creating an aggregated data set that includes a total aggregated conversion credit value where each value is specific to an Ad ID but aggregated across all ad publishers and users;
calculating an advertising recommendation, based on the aggregated conversion credit value; and
sending the calculated advertising recommendation to an advertising entity.

2. The method of claim 1, wherein the advertiser and a plurality of publishers each use a different encryption parameter from one another to perform the anonymization.

3. The method of claim 1, wherein the advertiser and a plurality of publishers all use a common encryption parameter.

4. The method of claim 1, further comprising:
receiving at the processor from the advertiser and from the publisher, secret data describing a successive encryption to be performed at the processor, and wherein the plurality of anonymized publisher-user identifiers and the plurality of anonymized advertiser-user identifiers are successive encrypted using the received secret data to compare the anonymized advertiser user identifiers with the anonymized publisher user identifiers.

5. The method of claim 4, wherein the plurality of anonymized publisher-user identifiers and the plurality of anonymized advertiser-user identifiers are anonymized by applying a successive encryption algorithm to the plurality of anonymized publisher-user identifiers and the plurality of anonymized advertiser-user identifiers.

6. The method of claim 1, wherein the conversion model includes applying credit based on a timing of an advertising event, and wherein credit is only granted to those advertising events that occurred before the conversion event, and by how many hours or days before, and wherein credit is granted differently to those advertising events that occurred before or after other advertising events.

7. The method of claim 6, wherein the result of the timing comparison is calculated based on timestamps associated with a conversion event or one or more advertising events but without exposing the timestamps in unencrypted form.

8. The method of claim 1, further comprising:
sending encryption algorithm parameters to the ad publisher.

9. The method of claim 2, wherein the conversion model is based on ad information that pertains to an advertising event, the ad information including at least one of a type of the advertising event, an ID for a user who viewed the advertisement, the date of the event, a time of the event, an ID for the advertisement itself, an ID for targets for the advertisement, or a campaign type.

10. The method of claim 7, wherein the ad information is received from the publisher.

11. The method of claim 2, wherein the campaign type includes at least one of a branding campaign, a non-branding campaign, a display campaign, a map campaign, or a mobile campaign.

12. The method of claim 2, wherein the plurality of advertising events includes at least one of a user click on an advertisement, and a user view of an advertisement.

13. The method of claim 2, wherein the plurality of conversion events pertains to a product purchased by a user.

14. The method of claim 2, wherein the advertising recommendation includes at least one of: when to serve an ad, which ad to serve, how prominently to display an ad, where to display an ad, and to which users to display an ad.

15. A method, comprising:
receiving, at a processor, a plurality of anonymized publisher-user identifiers;
receiving, at the processor, a plurality of anonymized advertiser-user identifiers;
at the processor, without de-anonymizing any publisher-user identifiers in the received plurality of publisher-user identifiers and any advertiser-user identifiers in the received plurality of advertiser-user identifiers, obliviously computing an intersection among the received publisher-user identifiers and the received ad-user identifiers to create an intersection set containing at least one computed intersection among the plurality of advertiser-user identifiers and the publisher-user identifiers;
aggregating a plurality of data in the conversion data set, creating an aggregated data set; and
calculating an advertising recommendation based on the aggregated data set.

16. The method of claim 13, wherein the plurality of anonymized publisher-user identifiers is a first plurality of anonymized publisher-user identifiers, the intersection set is a first intersection set, and further comprising:
receiving at the processor a second plurality of anonymized publisher-user identifiers;
at the processor, without de-anonymizing any publisher-user identifiers in the second plurality of publisher-user identifiers, obliviously computing an intersection among the received publisher-user identifiers and the ad-user identifiers to create a second intersection set;
applying to each computed intersection in the second intersection set, a conversion credit based on a conversion model, creating a second conversion data set;
aggregating the data in the second conversion data set, creating an aggregated data set; and
calculating at the processor an advertising recommendation, based on the first conversion data set and second conversion data set.

17. The method of claim 12, further comprising sending the calculated advertising recommendation to an advertising entity.

18. A method comprising:
receiving a set of anonymized user IDs from an advertiser;
receiving a set of anonymized user IDs from an advertising publisher, the anonymized user IDs from the advertising publisher being anonymized by the same method as the anonymized user IDs from the advertiser;
obliviously computing an intersection among the anonymized user IDs to determine a set of matches between each anonymized user ID from the advertiser and each anonymized user ID from the advertising publisher;
assigning a conversion credit value to each match in the set of matches, the conversion credit value being based on a predetermined set of ad-interaction data rules;
aggregating the conversion credit values across all matches to create an aggregation set;
sending the aggregation set to the advertiser to use in determining a value of the first advertising publisher.

19. The method of claim 16, wherein the advertising publisher is a first advertising publisher, the set of matches is a first set of matches, the anonymized user IDs from the first advertising publisher is a first set of anonymized user IDs, the aggregation set is a first aggregation set, and further comprising:
receiving a second set of anonymized user IDs from a second publisher, the second set of anonymized user IDs being anonymized by the same method as the anonymized user IDs from the advertiser;
obliviously computing an intersection among the anonymized user IDs received from the advertiser, and the anonymized user IDs received from the second publisher to determine a second set of matches between each anonymized user ID from the advertiser and each anonymized user ID from the second advertising publisher;
assigning a new conversion credit value to each match in the second set of matches, the assigned conversion credit value being based on the predetermined set of ad-interaction data rules;
aggregating the new conversion credit values across all matches to create a second aggregation set;
sending the second aggregation set to the advertising to use in determining a relative value of the first advertising publisher and the second advertising publisher.

20. The method of claim 17, wherein each rule in the predetermined set of ad-interaction data rules is based on ad interaction data comprising at least one of a date an ad was served, a time the ad was served, a date an ad was clicked on, or a time an ad was clicked on.
